(19) United States
(12) Patent Application Publication
(10) Pub. No.: US 2026/0218627 A1
(43) Pub. Date: Jul. 30, 2026

(54) Composite Blast Media and Method for Media Blasting Gas Turbine Component Using Same

(71) Applicant: Chromalloy Gas Turbine LLC, Palm Beach Gardens, FL (US)

(72) Inventors: Michael Davis, Carrollton, GA (US); Paul Petherbridge, Selston (GB); Eric Tremsky, Tappan, NY (US)

(21) Appl. No.: 19/036,466

(22) Filed: Jan. 24, 2025

(51) Int. Cl. F01D 25/00; B24C 1/00; B24C 11/00

(52) U.S. Cl. CPC F01D 25/002; B24C 1/00; B24C 11/00; F05D 2230/10

(57) ABSTRACT

A system for treating a gas turbine component to effectuate a change in a surface of the gas turbine component is disclosed. The system includes a composite blast media configured to be propelled onto the surface of the gas turbine component using a media blasting device. The composite blast media includes a carrier material and abrasive media embedded in the carrier material. The carrier material entraps at least a part of a substance released from the surface upon contact with the composite blast media.

### CROSS REFERENCE TO RELATED APPLICATIONS

None.

### FIELD OF THE DISCLOSURE

The disclosure relates generally to the field of media blasting components. More specifically, the disclosure relates to media blasting a gas turbine component with carrier material having abrasive particulates embedded therein.

### SUMMARY

The following presents a summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In an aspect, a system for treating a gas turbine component to effectuate a change in a surface of the gas turbine component is disclosed. The system includes composite blast media configured to be propelled onto the surface of the gas turbine component using a media blasting device. The composite blast media includes a carrier material and abrasive media embedded in the carrier material. The carrier material entraps at least a part of a substance released from the surface upon contact with the composite blast media.

In an aspect, according to any of the preceding aspects, the carrier material includes at least one void for entrapping the at least a part of a substance.

In an aspect, according to any of the preceding aspects, the gas turbine component is an aerospace component.

In an aspect, according to any of the preceding aspects, the aerospace component is at least one of a vane of a high pressure turbine and a blade of the high pressure turbine.

In an aspect, according to any of the preceding aspects, the carrier material includes polyurethane.

In an aspect, according to any of the preceding aspects, the abrasive media includes aluminum oxide.

In an aspect, according to any of the preceding aspects, the system is configured to remove coating from the surface of the aerospace component.

In an aspect, according to any of the preceding aspects, the system is configured to clean the surface of the aerospace component.

In an aspect, a method for media blasting a surface of a gas turbine component is provided. The method includes using a media blasting device to blast the surface of the gas turbine component with a composite blast media. The composite blast media includes a carrier material and abrasive media embedded in the carrier material. The carrier material entraps at least a part of a substance released from the surface upon contact with the composite blast media.

In an aspect, according to any of the preceding aspects, the carrier material includes at least one void for entrapping the at least a part of a substance.

In an aspect, according to any of the preceding aspects, the carrier material includes polyurethane.

In an aspect, according to any of the preceding aspects, the abrasive media includes aluminum oxide particulate.

In an aspect, according to any of the preceding aspects, the method includes blasting the composite blast media onto the surface to remove a coating from the surface.

In an aspect, according to any of the preceding aspects, the method includes blasting the composite blast media onto the surface to clean engine buildup from the surface.

In an aspect, according to any of the preceding aspects, the gas turbine component is an aerospace component.

### BRIEF DESCRIPTION OF THE DRAWINGS

Illustrative embodiments of the present disclosure are described in detail below with reference to the attached drawing figures and wherein:

FIG. 1 is a perspective view of a blade of a gas turbine engine, according to some aspects of the disclosure.

FIG. 2 is a perspective view of a vane of the gas turbine engine, according to some aspects of the disclosure.

FIGS. 3A-3C schematically illustrate media blasting a substrate using blast media, as in Prior Art.

FIG. 4 schematically shows a composite blast media, according to some aspects of the disclosure.

FIGS. 5A-5C schematically illustrate media blasting a substrate with composite blast media, according to some aspects of the disclosure.

FIG. 6A shows composite blast media under an electron microscope.

FIG. 6B shows results of a quantitative test of composite blast media.

FIG. 6C shows a spectrum overlay of composite blast media.

FIG. 6D shows results of an elemental scan of a test strip after it is impacted with composite blast media.

FIG. 7A shows surface profile measurements of standardized N1-almen test strips after these strips are impacted with standard blast media (220 Al2O3).

FIG. 7B shows surface profile measurements of standardized N1-almen test strips after these strips are impacted with composite blast media (220 Al2O3 embedded in carrier material).

FIG. 8 illustrates comparative stock loss measurements of N1-almen test strips impacted with standard blast media (220 Al2O3) and N1-almen test strips impacted with composite blast media (220 Al2O3 embedded in carrier material).

FIG. 9A shows surface profile measurements of N1-almen strips after these strips are impacted with standard blast media (60 Al2O3).

FIG. 9B shows surface profile measurements of N1-almen strips after these strips are impacted with composite blast media (60 Al2O3 embedded in carrier material).

FIG. 10 illustrates comparative stock loss measurements of N1-almen test strips impacted with standard blast media (60 Al2O3) and N1-almen test strips impacted with composite blast media (60 Al2O3 embedded in carrier material).

FIG. 11A shows work hardness results for respective N1-almen strips impacted with 220 Al2O3 , 60 Al2O3 , and 30/40 plastic.

FIG. 11B shows work hardness results for respective N1-almen strips impacted with 220 Al2O3 embedded in carrier material, 60 Al2O3 embedded in carrier material, and 30/40 plastic embedded in carrier material.

### DETAILED DESCRIPTION

A gas turbine engine typically includes a multi-stage compressor coupled to a multi-stage turbine via an axial shaft. Air enters the gas turbine engine through the compressor where its temperature and pressure are increased as it passes through subsequent stages of the compressor. The compressed air is then directed to one or more combustors where it is mixed with a fuel source to create a combustible mixture. This mixture is ignited in the combustors to create a flow of hot combustion gases. These gases are directed into the turbine causing the turbine to rotate, thereby driving the compressor. The output of the gas turbine engine can be mechanical thrust via exhaust from the turbine or shaft power from the rotation of an axial shaft, where the axial shaft can drive a generator to produce electricity.

The compressor and turbine each include a plurality of rotating blades and stationary vanes having an airfoil extending into the flow of compressed air or flow of hot combustion gases. Each blade or vane has a particular set of design criteria which must be met to provide the necessary work to the flow passing through the compressor and the turbine. However, due to the severe nature of the operating environment, especially in the turbine, it is often necessary to cool these blades and vanes. The blades and vanes often utilize complex internal cooling passageways in order to maximize the efficiency of cooling fluid passing therethrough. The internal cooling passageways are often operably linked to external cooling holes in the blade or vane which, during gas turbine engine operation, expel the cooling air from the internal cooling passageway to cool the blade or vane.

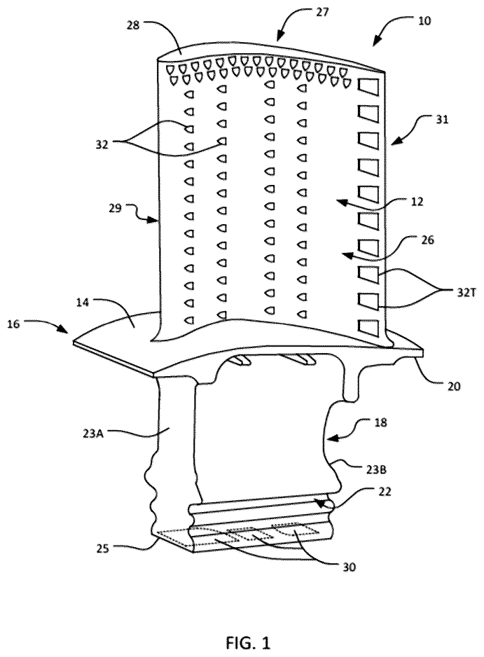

FIG. 1 shows a gas turbine component that is a blade 10. The blade 10 generally includes an airfoil 12 extending from a top or gas path side surface 14 of a platform 16 and a root fixing portion or “dovetail” 18 depending from an undersurface 20 of the platform 16. The dovetail 18 may include one or more serrations or tangs 22 that extend laterally from one side 23A of the dovetail 18 to an opposing side 23B of the dovetail 18. The dovetail 18 may terminate at a terminal or bottom wall 25 that may span between the dovetail sides 23A and 23B. The dovetail 18, including the tangs 22 and the bottom wall 25 thereof, may be adapted for interlocking engagement in a corresponding slot defined in the periphery of a hub of a turbine rotor.

The airfoil 12 may have a pressure side 26, a suction side 27 opposite the pressure side 26, a tip 28, a leading edge 29, and a trailing edge 31. The tip 28 may include or may be configured to interact with a shroud. The shroud may be provided at the tip 28 of each blade 10 or may be a stationary ring including one or more circumferentially extending sections each connected to the gas turbine casing. The shroud(s) may be configured to seal the gap between the tip 28 of the blade 10 and stationary components (e.g., stators) of the turbine, and thereby, may reduce leakage flow between the rotating and stationary components.

The airfoil 12, e.g., the pressure side 26 thereof, may come into contact with combustion gases that are at an extremely high temperature. The airfoil 12 or portions thereof may therefore be coated with heat-resistant, wear-resistant, and/or other coatings. During operation, the tip 28 may rub against the tip shroud, and the tip 28 may therefore additionally or alternately be coated with wear-resistant coatings. In like fashion, one or more other portions of the blade 10 may be coated with different materials depending on the environment in which these portions are located and the stresses encountered thereby.

The bottom wall 25 of the dovetail 18 may include one or more air inlet apertures 30. Further, one or more portions of the blade 10 may include cooling holes 32 for cooling the blade 10 during operation. The cooling holes 32 may be provided on one or more surfaces of the airfoil 12, such as the pressure side 26, the suction side 27, the tip 28, the leading edge 29, the trailing edge 31, or a combination thereof. The cooling holes 32 may be circular cooling holes, diffused (e.g., angled) cooling holes, cooling slots, or take on one or more other regular or irregular shapes. Cooling gas may pass through internal cooling channels (not illustrated for ease of description) in the blade 10 and emerge from the cooling holes 32 to create a blanket of thin film over the outer surface of the airfoil 12, thus preventing direct contact of the hot gases and the surfaces of the blade 10. For example, the illustrated blade 10 has air inlet apertures 30 in the bottom wall 25 of the dovetail 18 and cooling holes 32 on the pressure side 26 of the airfoil 12. The blade 10, including the airfoil 12 thereof, may include hollow interior passages for the passage of cooling air, for example, but not limited to, from air inlet apertures 30 to cooling holes 32. Thus, cooling air may be bled from the compressor and channeled into the air inlet apertures 30. This air may exit out the cooling holes 32 to cool one or more portions of the blade 10 during operation.

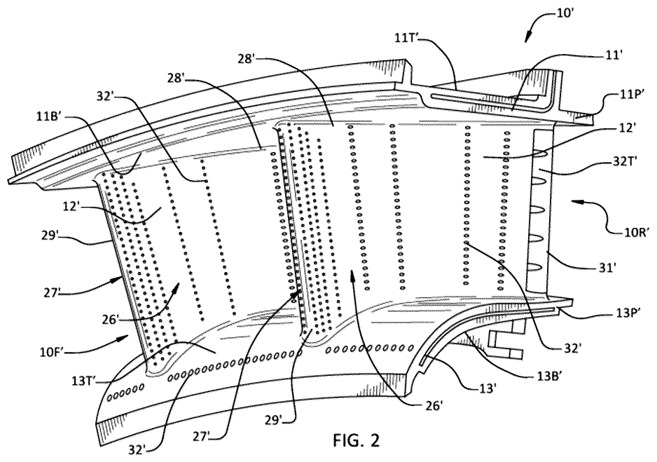

FIG. 2 shows a gas turbine vane 10'. Where the blade 10 may be designed as a rotating or moving component of the gas turbine engine, the vane 10′ may be intended as a stationary component of the gas turbine engine. The vane 10′ generally includes one or more airfoils 12′ extending between a bottom surface 11B′ of a top platform 11′ and a top surface 13T′ of a bottom platform 13′. The airfoils may generally extend from a front or leading end 10F′ of the top platform 11′ and bottom platform 13′ to a rear or trailing end 10R′ of the top platform 11′ and bottom platform 13′. The top platform 11′ and bottom platform 13′ may be adapted for interlocking engagement with a corresponding portion of the gas turbine engine (e.g., a corresponding slot defined in an area of the gas turbine engine adjacent the area of the gas turbine engine where one or more blades 10 are located). The vane 10′ may include one or more non-gas path surfaces, such as a top surface 11T′ of the top platform 11′, a perimeter 11P′ of the top platform 11′, a bottom surface 13B′ of the bottom platform 13′, and a perimeter 13P′ of the bottom platform 13′. These non-gas path surfaces may, in some aspects, have features for securing the vane 10′ to other parts of gas turbine engine.

Each of the airfoils 12′ may have a pressure side 26′, a suction side 27′ opposite the pressure side 26′, a tip 28′ engaged with the bottom surface 11B′, a leading edge 29′, and a trailing edge 31′. The top platform 11′ and bottom platform 13′ may be a part of a stationary ring including one or more circumferentially extending sections each connected to the gas turbine casing. The airfoils 12′, e.g., the pressure sides 26′ thereof, may come into contact with combustion gases that are at an extremely high temperature. The airfoils 12′ or portions thereof may therefore be coated with heat-resistant, wear-resistant, and/or other coatings. In like fashion, one or more other portions of the vane 10′ may be coated with different materials depending on the environment in which these portions are located and the stresses encountered thereby.

Like the blade 10, one or more portions of the vane 10′ may include cooling holes 32′ for cooling the vane 10′ during operation. The cooling holes 32′ may be provided on one or more surfaces of the airfoils 12′, such as the pressure side 26′, the suction side 27′, the leading edge 29′, the trailing edge 31′ (e.g., cooling holes 32T′), or a combination thereof. The cooling holes 32′ may alternately or additionally be located on other portions of the vane 10′, such as along the top surface 13T′ of the bottom platform 13′. The cooling holes 32′ may be circular cooling holes, diffused (e.g., angled) cooling holes, cooling slots, or take on one or more other regular or irregular shapes. Cooling gas may pass through internal cooling channels (not illustrated for ease of description) in the vane 10′ and emerge from the cooling holes 32′ to create a blanket of thin film over outer surfaces of the vane 10′, e.g., over the airfoils 12′, the bottom surface 11B′, the top surface 13T′, et cetera, thus preventing direct contact of the hot gases and those surfaces. For example, the illustrated vane 10′ may have air inlet apertures (not illustrated for ease of description) in the top platform 11′ and/or the bottom platform 13′. The vane 10′, including the airfoils 12′ thereof, may include hollow interior passages for the passage of cooling air, for example, but not limited to, to cooling holes 32′. Thus, cooling air may be bled from the compressor and channeled through to the cooling holes 32′. This air may exit out the cooling holes 32′ to cool one or more portions of the vane 10′ during operation.

Gas turbine components, and particularly components of gas turbines used in aircraft, may encounter harsh environments, e.g., extreme temperatures, high stresses, high levels of vibrations, high pressure debris, et cetera. One or more surfaces of these components may therefore be coated with one or more protective coatings to protect the components from the harsh environments during operation. For example, airfoil 12 of blade 10, and specifically pressure side 26 thereof, may come into contact with combustion gases that are at an extremely high temperature; pressure side 26 of airfoil 12 of blade 10 may therefore be coated with a thermal barrier coating (TBC) to insulate blade 10 from extreme heat generated during operation. As another example, tip 28 of airfoil 12 may frictionally contact (i.e., rub against) the tip shroud at a high rate of speed; tip 28 may therefore be coated with a wear-resistant coating to protect against damage. Other surfaces of blade 10, and surfaces of other gas turbine components, may likewise have protective coatings applied thereto depending on the environment in which these components are located and the stresses encountered thereby. The phrase “protective coating,” as used herein, includes any coating(s) that may be applied to a gas turbine component, and more specifically, to an aerospace component, to facilitate operation thereof, such as an environmental barrier coating (EBC), a thermal barrier coating (TBC), an anti-reflective coating, a wear-resistant coating, a corrosion-resistant coating, or another coating. “Protective coating” includes, but is not limited to, ceramic coating, aluminide coating (e.g., platinum aluminide coating and silicon aluminide coating), plasma coating, and chromide coating. The phrase “environmental coating,” as used herein, includes “protective coating” and any other substance that may be located on the surface of a gas turbine component, such as debris, engine scaling and hydrocarbon buildup, et cetera.

The phrase “media blasting,” as used herein, refers to a process whereby media is caused to contact or collide with a surface at high pressure (such as about 270 kPa or greater). For example, a media blasting device may be used to cause media to collide with a surface at high pressure to remove a coating on the surface, to clean the surface, or to effectuate another change in the surface.

One or more of several different types of media blasting (or media propelling) devices may be employed for treating a surface. For example, media may be blasted onto (i.e., caused to collide with) a surface using a direct pressure device, a suction device, a tumble blaster, et cetera. In a direct pressure device, media may be held in a pressurized vessel and may be pushed from behind and out a nozzle onto the target surface. In a suction device, a siphoning gun may be used to collect media that may then be delivered to a nozzle that pushes the media onto a surface. A tumble blaster may include a rotating basket and a blasting gun that causes media to collide with contents of the basket. Other types of media blasting systems, such as gravity-fed portable media blasting systems, may likewise be employed to cause media to collide with a surface.

Service or repair of a gas turbine component, such as blade 10, vane 10′, or another component, may involve impacting (such as blasting) the component with abrasive media to remove any environmental coating(s) on the surface of the component. Once the environmental coating(s) are removed, the component may be repaired, e.g., using laser welding, TIG welding, machining, or another technique. One or more environmental coatings (e.g., protective coatings) may then be reapplied to the surface of the component to complete the repair process. The surface of a gas turbine component, such as a new gas turbine component or a gas turbine component undergoing repair, may also be impacted with abrasive media to create peaks and valleys in the surface thereof (e.g., to facilitate coating).

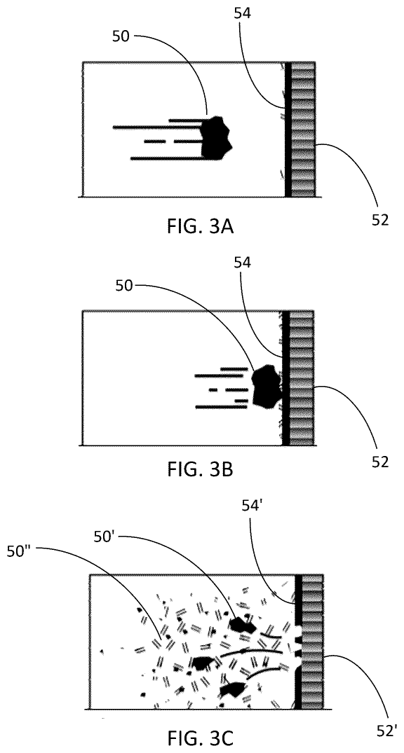

FIGS. 3A-3C schematically illustrate media blasting a substrate 52 using blast media 50, as in Prior Art. Substrate 52 may, e.g., be a surface of blade 10, vane 10′, or another aerospace component. Substrate 52 is coated with environmental coating 54 that is intended to be removed via the media blasting process.

As shown in FIG. 3A, (Prior Art), substrate 52 is impacted with standard blast media 50 to remove environmental coating 54. Standard blast media 50 may be plastic, aluminum oxide (e.g., 220 aluminum oxide, 320 aluminum oxide, et cetera), glass beads, or any other suitable media. FIG. 3B (Prior Art) shows standard blast media 50 contacting substrate 52, and specifically, environmental coating 54 thereon. FIG. 3C (Prior Art) shows substrate 52 after standard blast media 50 has collided therewith. Impact with substrate 52 causes blast media 50 to fracture (e.g., into fragments 50′, 50″, and other fragments) and remove one or more portions of environmental coating 54 (substrate 52 and environmental coating 54 after impact in FIG. 3C are referenced as substrate 52′ and environmental coating 54′).

This conventional method of media blasting substrate 52 using standard blast media 50 may have several shortcomings. Impact of standard blast media 50 with substrate 52 may fragmentize blasting media 50, e.g., into fragments 50′ and 50″, and these fragments 50′ and 50″ may be propelled into the atmosphere and ricochet into the air. The resulting impact may also release any contaminants in blasting media 50 into the air as airborne dust. These fragments 50′ and 50″ and the airborne dust may undesirably land on other portions of substrate 52, thus necessitating subsequent cleanup of substrate 52. If substrate 52 is associated with an aerospace component having openings (e.g., cooling holes, such as in of blade 10 or vane 10′), fragments 50′ and 50″ and the airborne dust may undesirably lodge in these openings—further complicating subsequent cleanup processes. Blasting media 50, or fragments 50′ and 50″ thereof, may also undesirably impregnate substrate 52 and cause damage thereto (e.g., a piece of blasting media 50 may be pushed into substrate 52 by another piece of blasting media 50 and impregnate substrate 52). Another drawback of blasting substrate 52 with conventional blasting media 50 may be that large amounts of heat may be undesirably transferred by blasting media 50 to substrate 52 upon impact, which may cause damage. Moreover, this conventional method of media blasting substrate 52 using standard blast media 50 may not be sufficiently controllable to ensure that blasting media 50 removes environmental coating 54 from substrate 52 without damaging substrate 52. In addition, standard blast media 50 may break down upon impact after one or two blasting operations and may thereafter have to be discarded.

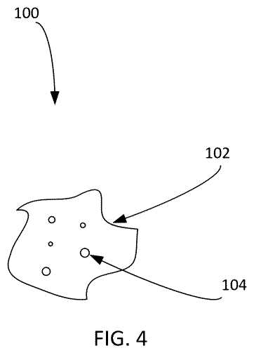

FIG. 4 shows composite blast media 100, according to some aspects of the disclosure. Composite blast media 100 may include at least two distinct constituents. In an aspect of the disclosure, composite blast media 100 includes at least a sponge or sponge-like carrier material (hereinafter carrier material 102) and abrasive media 104. Abrasive media 104, e.g., particulates thereof, may be embedded into carrier material 102 to form composite blast media 100.

Carrier material 102 may include any suitable material for carrying abrasive media 104. In some examples of the embodiments, carrier material 102 may be a sponge or sponge-like material, e.g., one or more of polyurethane, polyester, or another synthetic material. In some aspects of the disclosure, carrier material 102 used in composite blast media 100 may be finely ground, e.g., carrier material 102 may have a particle size of 3-6 mesh for some applications and a particle size of 6-8 mesh for other applications. In other examples of the embodiments, carrier material 102 may have a finer or coarser particle size. In an aspect of the disclosure, carrier material 102 (such as sponge or sponge-like material) may include on or more openings or voids.

Abrasive media 104 may include blasting media, including media conventionally used for blasting applications. Depending on the type of application, abrasive media 104 may include, e.g.: (a) minimally aggressive media, such as plastic, glass bead, 220 aluminum oxide (i.e., 220 Al2O3), and 320 Al2O3; (b) moderately aggressive media, such as 60 Al2O3, 80 Al2O3, and 120 Al2O3, and garnet; and (c) highly aggressive media, such as steel sponge, 16 Al2O3, and 30 Al2O3. This list is exemplary and is not intended to be exhaustive. In some aspects of the disclosure, abrasive media 104 may include two or more types of abrasive media. In some aspects of the disclosure, abrasive media 104 may include at least one abrasive constituent and at least one non-abrasive constituent.

Aggressiveness of abrasive media 104 may depend on the rate at which material is removed from a given substrate when that substrate is impacted with abrasive media 104. Specifically, all other factors (such as blast pressure, type of substrate, and distance between substrate and abrasive media 104) being equal, minimally aggressive abrasive media 104 may remove less material from a given substrate upon impact as compared to moderately aggressive abrasive media 104, and moderately aggressive abrasive media 104 may remove less material from that substrate upon impact as compared to highly aggressive abrasive media 104. Composite blast media 100 that includes abrasive media 104 that is minimally aggressive may be employed, e.g., for cleaning the surface of component (e.g., removing engine scaling and hydrocarbon buildup thereon) and for stripping coating from the surface of a component. Composite blast media 100 that includes abrasive media 104 that is moderately aggressive may be employed, e.g., for aggressively cleaning the surface of a component and for creating peaks and valleys in the surface of a component to prepare the surface to receive coating (e.g., plasma coating). Composite blast media 100 that includes abrasive media 104 that is highly aggressive may be employed, e.g., for removing tough coatings, rust, and the like from the surface of a component. These applications of the different types of abrasive media 104 are exemplary only and are not intended to be independently limiting, but instead, are meant to illustrate that composite blast media 100 may include different types of abrasive media 104 based on the requirements of a particular application.

In some examples of the embodiments, composite blast media 100 may include carrier material 102 and be devoid of abrasive media 104. Such composite blast media 100 may be used, e.g., for inexpensively cleaning large machinery (such as for cleaning autoclaves, a process that typically costs many thousands of dollars).

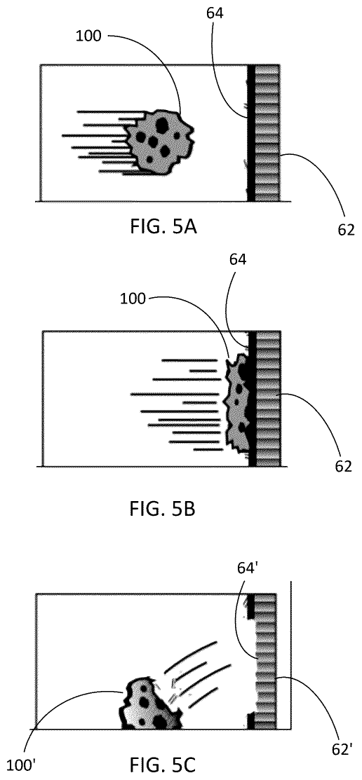

FIGS. 5A-5C schematically illustrate media blasting a substrate 62 using composite blast media 100. Substrate 62 may, e.g., be a surface of blade 10, vane 10′, or another aerospace component. Substrate 62 is coated with environmental coating 64 that is intended to be removed via the media blasting process. Substrate 62 and environmental coating 64 may be identical to substrate 52 and environmental coating 54 shown in FIG. 3A.

FIG. 5A shows composite blast media 100 being blasted or propelled towards substrate 62, and FIG. 5B shows composite blast media 100 contacting substrate 62, and specifically, environmental coating 64 thereon. FIG. 5C shows substrate 62 after composite blast media 100 has collided therewith (substrate 62, environmental coating 64, and composite blast media 100, after impact in FIG. 5C, are respectively referenced as substrate 62′, environmental coating 64′, and composite blast media 100′).

As illustrated in FIGS. 5B-5C, unlike standard blast media 50 that fragments upon impact (see FIG. 3C (Prior Art)), composite blast media 100 compresses upon impact (see FIG. 5B) and absorbs or partly absorbs the collision energy—there is no or minimal fracturing of composite blast media 100 upon impact (see FIG. 5C). As such, composite blast media 100′ may be reused for media blasting numerous other components (e.g., composite blast media 100′ may be reused fifty times or more).

In some examples, composite blast media 100 entraps, retains, or otherwise enables part of a substance (such as particulates of coating on substrate 62 or contaminants in composite blast media 100) released upon impact of the composite blast media 100 with substrate 62 to be captured (hereinafter “entrapped”), for example, by carrier material 102 of composite blast media 100. As noted, carrier material 102 (such as sponge or sponge-like material) of composite blast media 100 may include one or more voids. Carrier material 102 of composite blast media 100 may temporarily flatten or otherwise deform upon impact of composite blast media 100 with substrate 62, and this flattening of carrier material 102 may cause the one or more voids in carrier material 102 to temporarily expand. As carrier material 102 begins to return to its original shape, the one or more voids therein may contract, and at least part of a substance released upon impact of composite blast media 100 with substrate 62 may be captured within these contracting voids, The composite blast media 100 may then deposit the captured substance in the extraction system of the media blasting apparatus, away from substrate 62. Such may eliminate or at least reduce the need for cleanup of substrate 62 after substrate 62 is impacted with composite blast media 100. This may be particularly advantageous where substrate 62 is associated with an aerospace component having openings (such as cooling holes), as it may be cumbersome to remove media (e.g., standard blast media 50) that is lodged therein. In addition, and as discussed herein, composite blast media 100 may be employed to more controllably blast substrate 62 to remove environmental coating 64 thereon, and as such, may reduce the likelihood of damaging substrate 62.

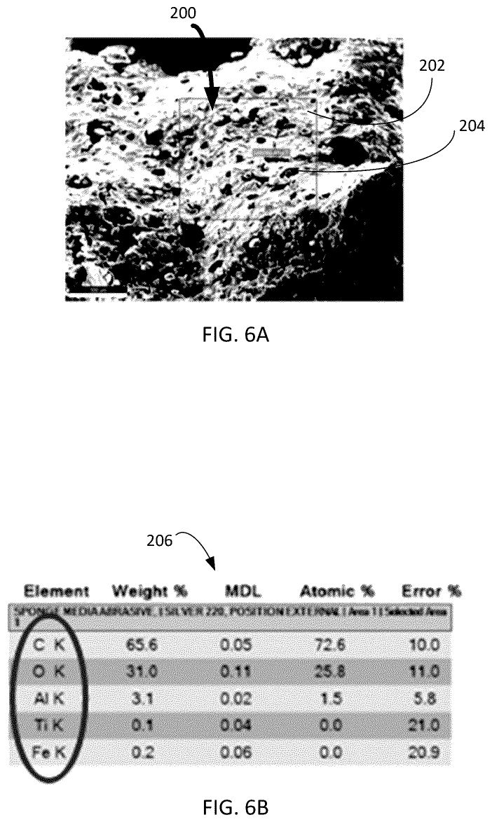

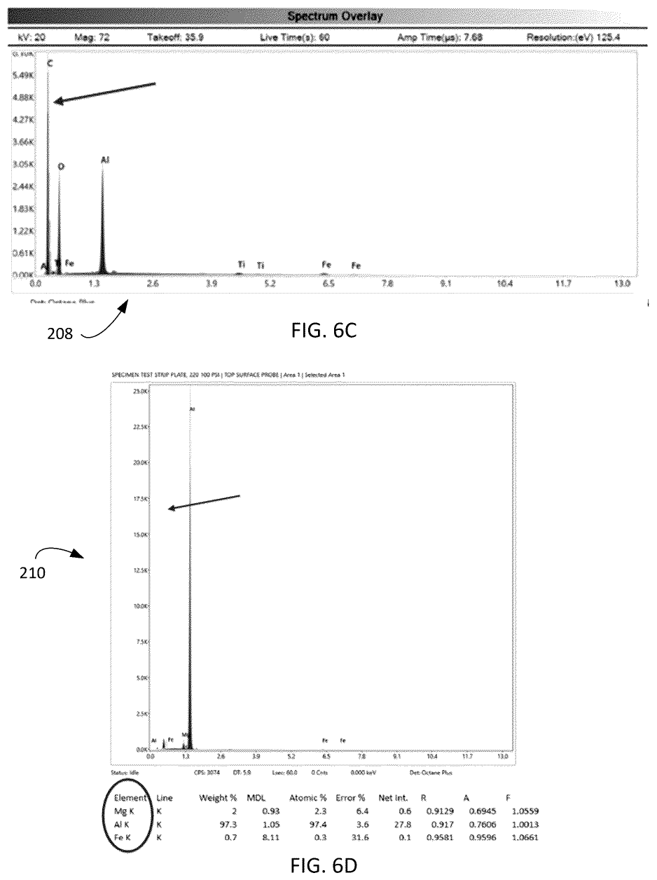

As discussed above, standard blast media 50 has a propensity to get impregnated in the substrate being impacted (e.g., one piece of blasting media 50 may be pushed into the substrate being impacted by another piece of blasting media 50 and thereby impregnate the substrate). FIGS. 6A-6D demonstrate that, unlike standard blast media 50, composite blast media 100 does not (or at least is less likely to) impregnate a substrate.

Specifically, FIG. 6A shows composite blast media 200 under an electron microscope. Composite blast media 200 is an example of composite blast media 100 (i.e., composite blast media 200 includes carrier material 202 and abrasive media 204 that generally correspond to carrier material 102 and abrasive media 104, respectively). In the illustrated example, composite blast media 200 includes 220 aluminum oxide (i.e., 220 grit Al2O3) embedded in polyurethane foam. That is, carrier material 202 of composite blast media 200 includes polyurethane foam and abrasive media 204 of composite blast media 200 includes aluminum oxide.

FIG. 6B shows results 206 of a quantitative test of composite blast media 200. As can be seen, as carrier material 202 of composite blast media 200 is polyurethane foam (i.e., is carbon-based), results 206 indicate that the elemental makeup of composite blast media 200 is largely carbon-based. Results 206 also show that composite blast media 200 includes aluminum, oxygen, and some impurities (Ti (titanium) and Fe (iron) in this example).

FIG. 6C shows a spectrum overlay 208 of composite blast media 200. Spectrum overlay 208, like results 206, indicates that the primary constituent of composite blast media 200 is carbon, and that composite blast media 200 also includes aluminum, oxygen, titanium, and iron.

FIG. 6D shows results 210 of an elemental scan of a substrate (a 6061-T6 aluminum test strip in this example) after it is impacted with composite blast media 200 at a pressure of 100 PSI (689.4 kPa). Results 210 indicate presence of aluminum, iron, and magnesium. Results 210 also indicate absence of carbon. That is, results 210 show that no (or only a nonappreciable quantity of) carrier material 202 is left on the test strip after the blasting process. The results 210 therefore indicate that, unlike standard blast media 50, composite blast media 200 does not (or is at least less likely to) impregnate the substrate being blasted.

Another benefit of blasting a substrate using composite blast media 100 as compared to standard blast media 50 may be increased efficiency and time-savings, and a corresponding reduction in cost. For example, ceramic coatings on an aerospace component (such as blade 10 or vane 10′) are conventionally removed in an autoclave environment using chemical etching. This conventional process may take many hours, or even days, and may damage the component. Conversely, composite blast media 100 may be blasted or propelled on the component to remove the ceramic coating in a matter of minutes while simultaneously reducing the likelihood of the component sustaining damage.

Similarly, bond coat (e.g., an NiCrAlY coating) on an aerospace component (bond coat may act as a base layer for ceramic coating and facilitate adherence of ceramic coating to the component) is conventionally removed using water jet stripping or an acid bath (e.g., a hydrochloric acid bath). Composite blast media 100 may be blasted or propelled onto the surface of the component to remove the bond coat thereon in a more efficient and cost-effective manner.

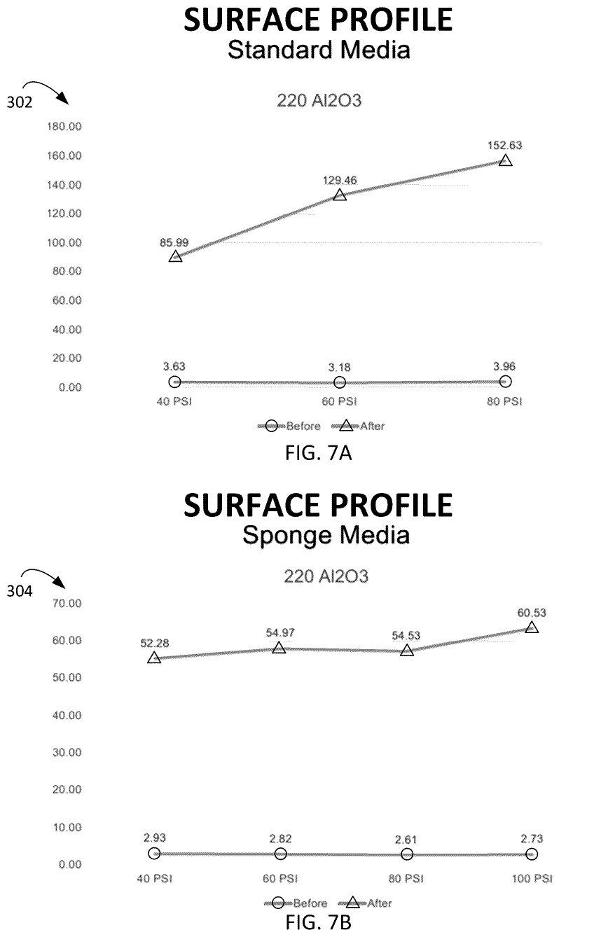

Blasting a component using composite blast media 100 may also be more controllable and forgiving relative to blasting the component using standard blast media 50. Media blasting a component using composite blast media 100 may therefore reduce the likelihood of damaging the component as compared to media blasting the component using standard blast media 50. FIGS. 7A-7B illustrate this benefit.

As noted above, 220 Al2O3 is a minimally aggressive standard blast media 50 (or abrasive media 100) that may be blasted or propelled onto the surface of a component for cleaning the surface of a component and stripping coatings thereon. In such applications, it may be desirable to prevent or at least minimize changes to the surface profile of the substrate and the stock loss thereof. Surface profile of a substrate is a measurement of the peak-to-valley height, and it may be desirable to clean the substrate without introducing substantial peaks and valleys in the substrate during the cleaning process. Stock loss is a measure of the substrate that is removed during the media blasting (or other) process, and it may be desirable to prevent or at least minimize stock loss associated with the cleaning process.

FIG. 7A shows surface profile measurements 302 (i.e., peak-to-valley height of a surface) of standardized N1-almen test strips after these strips are impacted with standard blast media 50 (220 Al2O3 in this example), and FIG. 7B shows surface profile measurements 304 of standardized N1-almen test strips after these strips are impacted with composite blast media 100 (220 Al2O3 embedded in carrier media in this example). In this test, pressure pot machines were used to blast each of the standard blast media 50 and composite blast media 100 onto the N1-almen test strips.

As can be seen in FIGS. 7A-7B, the surface profile of an N1-almen test strip impacted with lightly aggressive standard blast media 50 (220 Al2O3 in this example) at a pressure of 40 PSI (275.8 kPa) is 85.99 micrometers (μm) (see FIG. 7A), whereas the surface profile of an N1-almen test strip impacted with composite blast media 100 (220 Al2O3 embedded in carrier media in this example) at the same pressure of 40 PSI is only 52.28 μm (see FIG. 7B). Similarly, the surface profile of an N1-almen test strip impacted with lightly aggressive standard blast media 50 (220 Al2O3 in this example) at a pressure of 60 PSI is 129.46 μm (see FIG. 7A), whereas the surface profile of an N1-almen test strip impacted with composite blast media 100 (220 Al2O3 embedded in carrier media in this example) at 60 PSI is only 54.97 μm (see FIG. 7B). Likewise, the surface profile of an N1-almen test strip impacted with lightly aggressive standard blast media 50 (220 Al2O3 in this example) at a pressure of 80 PSI is 152.63 μm (see FIG. 7A), whereas the surface profile of an N1-almen test strip impacted with composite blast media 100 (220 Al2O3 embedded in carrier media in this example) at 80 PSI is only 54.53 μm (see FIG. 7B).

A comparison of surface profile measurements 302 and surface profile measurements 304 illustrates that: (a) at the same blasting pressure, minimally aggressive standard blast media 50 (220 Al2O3 in this example) has a greater impact on surface profile of a substrate as compared to composite blast media 100 that includes minimally aggressive abrasive media 104 (i.e., composite blast media 100 includes 220 Al2O3 embedded in carrier material 102 in this example); and (b) increasing blasting pressure of minimally aggressive standard blast media 50 (220 Al2O3 in this example) has a greater impact on surface profile of a substrate relative to increasing, by the same amount, blasting pressure of composite blast media 100 that includes minimally aggressive abrasive media 104 (220 Al2O3 embedded in carrier material 102 in this example). Surface profile measurements 302 and surface profile measurements 304 thus indicate that an operator of a blasting apparatus may blast a substrate using composite blast media 100 having minimally aggressive abrasive media 104 to clean or strip the substrate more controllably, and that use of such composite blast media 100 to clean a substrate may be more forgiving for the operator relative to blasting the substrate using minimally aggressive standard blast media 50.

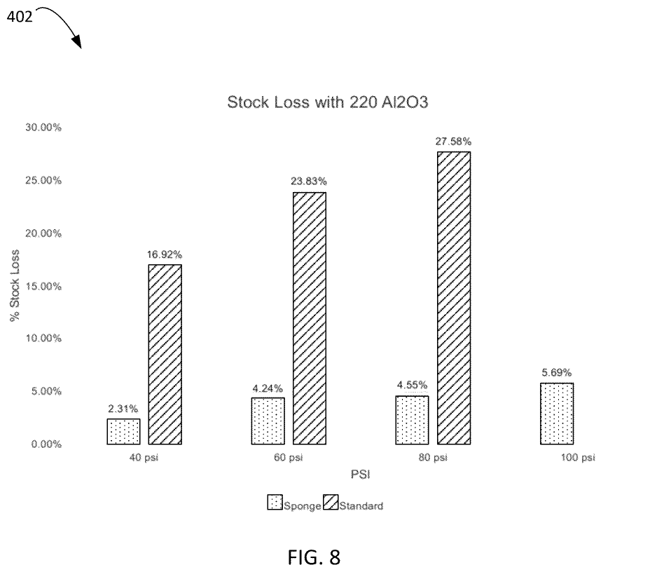

FIG. 8 illustrates stock loss measurements 402 (in bar graph format) of N1-almen test strips impacted with minimally aggressive standard blast media 50 (220 Al2O3 in this example), and of N1-almen test strips impacted with composite blast media 100 that includes minimally aggressive abrasive media 104 (i.e., composite blast media 100 includes minimally aggressive abrasive media 104 (220 Al2O3 in this example) embedded in carrier material 102). The same distance was maintained between: (a) the N1-almen test strips and the blasting nozzle blasting these test strips with standard blast media 50; and (b) the N1-almen test strips and the blasting nozzle blasting these test strips with composite blast media 100. Further, the same nozzle was used to blast each of the standard blast media 50 and the composite blast media 100 onto the respective N1-almen test strips, and each of standard blast media 50 and composite blast media 100 was blasted or propelled onto the respective N1-almen strips for the same amount of time (20 seconds+/−2 seconds in this test) using a pressure pot machine. Three samples were taken for each blast pressure and the measurements were rounded to two decimal places for comparison.

As can be seen in FIG. 8, at a blast pressure of 40 PSI (275.8 kPa), N1-almen test strips impacted with minimally aggressive standard blast media 50 (220 Al2O3 in this example) exhibited a 16.29% stock loss, whereas N1-almen test strips impacted at the same pressure of 40 PSI (275.8 kPa) with composite blast media 100 that includes carrier material 102 and minimally aggressive abrasive media 104 (220 Al2O3 in this example) exhibited a stock loss of only 2.31%. Similarly, at a blast pressure of 60 PSI (413.7 kPa), N1-almen test strips impacted with minimally aggressive standard blast media 50 (220 Al2O3 in this example) exhibited a 23.83% stock loss, whereas N1-almen test strips impacted with composite blast media 100 (i.e., 220 Al2O3 embedded in carrier material 102) at 60 PSI (413.7 kPa) exhibited a stock loss of only 4.24%. In the same vein, at a blast pressure of 80 PSI (551.6 kPa), N1-almen test strips impacted with minimally aggressive standard blast media 50 (220 Al2O3 in this example) exhibited a 27.58% stock loss, whereas N1-almen test strips blasted at 80 PSI (551.6 kPa) with composite blast media 100 (220 Al2O3 embedded in carrier material 102) exhibited a stock loss of only 4.55%. The stock loss measurements 402 therefore indicate that a substrate may be impacted with composite blast media 100 that includes minimally aggressive abrasive media 104 more controllably relative to standard blast media 50 that is minimally aggressive, and that this composite blast media 100 may be more forgiving than minimally aggressive standard blast media 50.

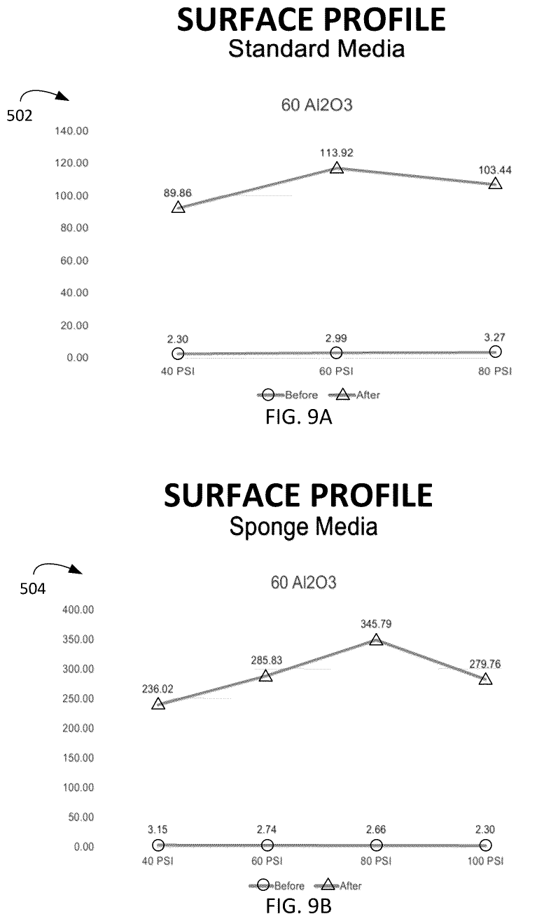

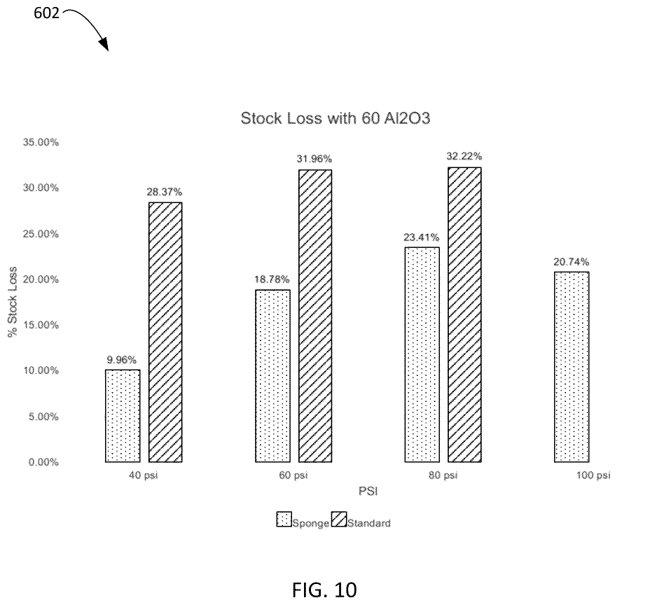

As discussed above, FIG. 7A shows surface profile measurements 302 of N1-almen strips impacted with minimally abrasive standard blast media 50 (specifically, 220 Al2O3), and FIG. 7B shows surface profile measurements 304 of N1-almen strips impacted with minimally abrasive composite blast media 100 (specifically, 220 Al2O3 embedded in carrier material 102). As also discussed above, minimally abrasive media (such as 220 Al2O3) may be blasted or propelled onto a substrate for cleaning and stripping applications, and in such applications, it is desirable to prevent or at least minimize changes to the surface profile of the substrate. Conversely, when media blasting the surface of a component with moderately aggressive media (such as 60 Al2O3) to prepare the surface to receive certain types of coating (e.g., plasma coating), it may be desirable to increase roughness and surface profile, as more pronounced peaks and valleys may enable the surface to better accept the coating. FIGS. 9A-9B and 10 illustrate that blasting a substrate with composite blast media 100 that includes moderately aggressive abrasive media 104 (e.g., 60 Al2O3) creates more distinct peaks and valleys in the substrate relative to blasting the substrate with 60 Al2O3 alone.

Specifically, FIG. 9A shows surface profile measurements 502 of N1-almen strips impacted with standard blast media 50 (60 Al2O3 in this example), and FIG. 9B shows surface profile measurements 504 of N1-almen strips impacted with composite blast media 100 (60 Al2O3 as abrasive media 104 embedded in carrier material 102 in this example). In this test, pressure pot machines were used to blast each of the standard blast media 50 and composite blast media 100 onto the N1-almen test strips.

As can be seen in FIGS. 9A-9B, the surface profile of an N1-almen test strip impacted with moderately aggressive standard blast media 50 (60 Al2O3 in this example) at a pressure of 40 PSI is 89.86 micrometers (μm) (see FIG. 9A), whereas the surface profile of an N1-almen test strip impacted with composite blast media 100 that includes moderately aggressive abrasive media 104 (60 Al2O3 embedded in carrier material 102 in this example) at the same pressure of 40 PSI is significantly higher at 236.02 μm (see FIG. 9B). Similarly, the surface profile of an N1-almen test strip impacted with standard blast media 50 (60 Al2O3 in this example) at a pressure of 60 PSI is 113.92 μm (see FIG. 9A), whereas the surface profile of an N1-almen test strip impacted with composite blast media 100 that includes moderately aggressive abrasive media 104 (60 Al2O3 embedded in carrier material 102 in this example) at 60 PSI is significantly higher at 285.83 μm (see FIG. 9B). Likewise, the surface profile of an N1-almen test strip impacted with moderately aggressive standard blast media 50 (60 Al2O3 in this example) at a pressure of 80 PSI is 103.44 μm, whereas the surface profile of an N1-almen test strip impacted with composite blast media 100 (60 Al2O3 embedded in carrier material 102 in this example) at 80 PSI is significantly higher at 345.79 μm.

A comparison of surface profile measurements 502 and surface profile measurements 504 illustrates that: (a) at the same blasting pressure, moderately aggressive standard blast media 50 (60 Al2O3 in this example) has a smaller impact on the surface profile of a substrate as compared to composite blast media 100 that includes moderately aggressive abrasive media 104 (60 Al2O3 embedded in carrier material 102 in this example); and (b) increasing blasting pressure of moderately aggressive standard blast media 50 (60 Al2O3 in this example) has a smaller impact on the surface profile of a substrate relative to increasing, by the same amount, blasting pressure of composite blast media 100 that includes moderately aggressive abrasive media 104 (60 Al2O3 embedded in carrier material 102 in this example). Surface profile measurements 502 and surface profile measurements 504 thus indicate that composite blast media 100 that includes moderately aggressive abrasive media 104 (such as 60 Al2O3) embedded in carrier material 102 may have a greater impact on surface profile of a substrate relative to blasting the substrate with moderately aggressive standard blast media 50 (e.g., 60 Al2O3) alone. That is, when blasting a substrate to introduce peaks and valleys therein (e.g., so that the substrate can better accept a coating), it may be more desirable to blast the substrate with composite blast media 100 that includes carrier material 102 and moderately aggressive abrasive media 104 (e.g., 60 Al2O3) relative to blasting the substrate with moderately aggressive standard blast media 50 (e.g., 60 Al2O3) alone.

FIG. 10 illustrates stock loss measurements 602 of N1-almen test strips impacted with moderately aggressive standard blast media 50 (60 Al2O3 in this example), and of N1-almen test strips impacted with composite blast media 100 that includes carrier material 102 and moderately aggressive abrasive media 104 (60 Al2O3 in this example). As can be seen in FIG. 10, at a blast pressure of 40 PSI (275.7 kPa), N1-almen test strips impacted with moderately aggressive standard blast media 50 (60 Al2O3 in this example) exhibited a 28.37% stock loss, whereas N1-almen test strips blasted at the same pressure of 40 PSI (275.7 kPa) with composite blast media 100 that includes moderately aggressive abrasive media 104 (60 Al2O3 embedded in carrier material 102 in this example) exhibited a stock loss of only 9.96%. Similarly, at a blast pressure of 60 PSI (413.7 kPa), N1-almen test strips impacted with moderately aggressive standard blast media 50 (60 Al2O3 in this example) exhibited a 31.96% stock loss, whereas N1-almen test strips impacted with composite blast media 100 (60 Al2O3 embedded in carrier material 102 in this example) at 60 PSI (413.7 kPa) exhibited a stock loss of only 18.78%. In the same vein, at a blast pressure of 80 PSI (551.6 kPa), N1-almen test strips impacted with moderately aggressive standard blast media 50 (60 Al2O3 in this example) exhibited a 32.22% stock loss, whereas N1-almen test strips blasted at 80 PSI (551.6 kPa) with composite blast media 100 (60 Al2O3 embedded in carrier material 102 in this example) exhibited a stock loss of only 23.41%. FIGS. 9A-9B, together with FIG. 10, therefore indicate that: (a) blasting composite blast media 100 that includes moderately aggressive abrasive media 104 (60 Al2O3 embedded in carrier material 102 in this example) onto a substrate may create sharper peaks and valleys relative to blasting the substrate with moderately aggressive standard blast media 50 alone (60 Al2O3 in this example) alone; and (b) the sharper peaks and valleys are created notwithstanding the fact that blasting the substrate with composite blast media 100 (60 Al2O3 embedded in carrier material 102 in this example) results in less stock loss relative to blasting the substrate with moderately aggressive standard blast media 50 alone. Put differently, composite blast media 100 with moderately aggressive abrasive media 104 (60 Al2O3 embedded in carrier material 102 in this example) may create a rougher surface that is better configured to accept a coating, while at the same time, result in less material loss, relative to blasting the substrate with moderately aggressive standard blast media 50 (60 Al2O3 in this example) alone.

A substrate, e.g., a surface of an aerospace component, may have to be annealed (i.e., softened), as a substrate with reduced hardness may be easier to work with. The Hardness Rockwell Scale (HRA, HRB, or HRC) is a measure of hardness of materials. For example, a steel strip having a hardness of 40 HRC may be harder than a steel strip having a hardness of 20 HRC.

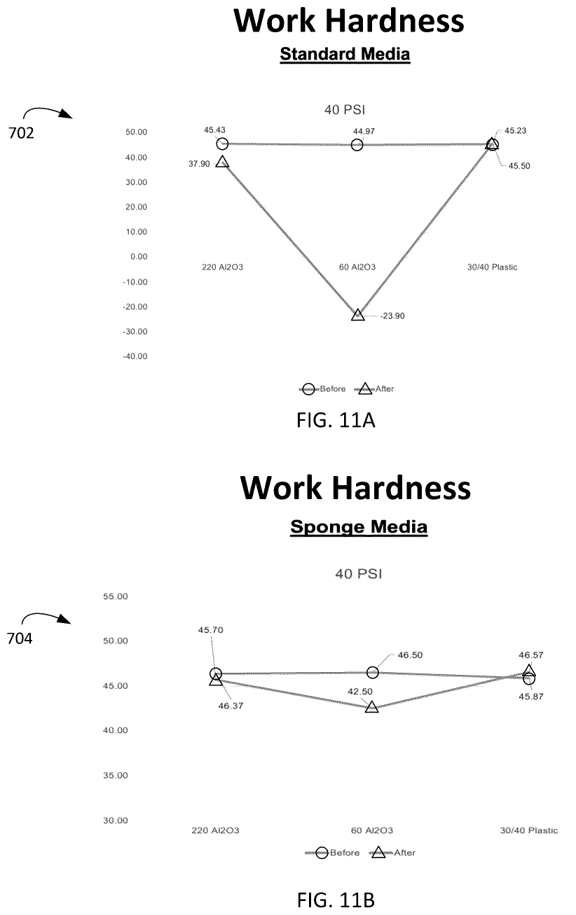

FIGS. 11A and 11B respectively show work hardness of N1-almen strips impacted with standard blast media 50 and composite blast media 100. Specifically, FIG. 11A shows work hardness results 702 for N1-almen strips impacted with: (a) 220 Al2O3; (b) 60 Al2O3; and (c) 30/40 plastic, and FIG. 11B shows work hardness results of N1-almen strips impacted with (a) 220 Al2O3 as abrasive material 104 embedded in carrier material 102; (b) 60 Al2O3 as abrasive material 104 embedded in carrier material 102; and (c) 30/40 plastic as abrasive material 104 embedded in carrier material 102. In this comparative test, each N1-almen strip impacted with standard blast media 50 or with composite blast media 100 was impacted in one fixed location at 40 PSI for 20 seconds (+/−2 seconds).

FIG. 11A shows that blasting an N1-almen strip with 220 Al2O3 (i.e., minimally aggressive standard blast media 50) at 40 PSI for 20 seconds reduced the hardness of the strip from 45.43 HRC to 37.90 HRC (a change of 7.53 HRC). Conversely, FIG. 11B shows that blasting an N1-almen strip with composite blast media 100 (220 Al2O3 embedded in abrasive media 104) at 40 PSI for 20 seconds reduced the hardness of the strip from 46.37 HRC to 45.70 HRC (a change of only 0.67 HRC).

FIG. 11A likewise shows that blasting an N1-almen strip with 60 Al2O3 (i.e., moderately aggressive standard blast media 50) at 40 PSI for 20 seconds reduced the hardness of the strip from 44.97 HRC to −23.90 HRC (a change of 68.87 HRC). Conversely, FIG. 11B shows that blasting an N1-almen strip with composite blast media 100 (60 Al2O3 embedded in carrier material 102) at 40 PSI for 20 seconds reduced the hardness of the strip from 46.50 HRC to 42.50 HRC (a change of only 4.00 HRC).

FIG. 11A also shows that blasting an N1-almen strip with 30/40 plastic (i.e., negligibly aggressive standard blast media 50) at 40 PSI for 20 seconds reduced the hardness of the strip from 45.50 HRC to 45.23 HRC (a change of 0.27 HRC). FIG. 11B shows that blasting an N1-almen strip with composite blast media 100 (30/40 plastic embedded in carrier material 102) at 40 PSI for 20 seconds reduced the hardness of the strip from 46.57 HRC to 45.87 HRC (a change of 0.7 HRC).

Work hardness results 702 and 704 thus show: (a) blasting a substrate (N1-almen strip in this example) with minimally aggressive standard blast media 50, such as 220 Al2O3, has a greater impact on work hardness relative to blasting that substrate with composite blast media 100 that includes minimally aggressive abrasive media 104 (such as 220 Al2O3 as abrasive material 104 embedded in carrier material 102); and (b) blasting a substrate (N1-almen strip in this example) with moderately aggressive standard blast media 50, such as 60 Al2O3, has a greater impact on work hardness relative to blasting that substrate with composite blast media 100 that includes moderately aggressive abrasive media 104 (such as 60 Al2O3 as abrasive media 104 embedded in carrier material 102). The work hardness results 702 and 704 therefore indicate blasting a substrate with standard blast media 50 may be less forgiving than blasting the substrate with corresponding composite blast media 100. These work hardness results 702 and 704 also demonstrate that, all other things being equal, more heat is undesirably generated when blasting a substrate (N1-almen strip in this example) with: (a) minimally aggressive standard blast media 50 (220 Al2O3 in this example) relative to blasting the substrate with composite blast media 100 that includes 220 Al2O3 as abrasive material embedded in carrier material 102; and (b) moderately aggressive standard blast media 50 (60 Al2O3 in this example) relative to blasting the substrate with composite blast media 100 that includes 60 Al2O3 as abrasive material 104 embedded in carrier material 102.

Thus, as has been described, media blasting a gas turbine component (such as an aerospace component) with composite blast media 100 (i.e., blast media that includes carrier material 102 and abrasive media 104) may have one or more benefits relative to media blasting that component with standard blast media 50. As one example, all other things being equal, blasting a gas turbine component with standard blast media 50 may transfer more heat to the component and generate more dust relative to blasting that component with corresponding composite blast media 100. As another example, composite blast media 100 may be more forgiving for an operator relative to standard blast media 50 that does not include any carrier material 102. As yet another example, when preparing a substrate to receive coating (e.g., plasma coating), blasting that substrate with composite blast media 100 (e.g., composite blast media 100 that includes moderately aggressive abrasive media 104 embedded in carrier material 102) may have a greater impact on surface profile relative to blasting that substrate with moderately aggressive standard blast media 50, while at the same time, composite blast media 100 may result in reduced stock loss relative to standard blast media 50.

FIGS. 6B-11B illustrate that composite blast media 100 may be particularly suitable for treating or impacting gas turbine components, and more specifically, aerospace components. For example, FIGS. 7A-8 illustrate that composite blast media 100, as embodied by the disclosure, can be used more controllably and with reduced stock losses relative to known blast media. The controllability and reduced stock losses are important in the aerospace industry where aerospace components have tight tolerances. The controllability and reduced stock losses may not be important in other industries.

In some examples, the composite blast media 100 may be used to treat components of land based power generation systems, including solar turbine engine components. These components may include, for example, seals, diaphragms, turbine and compressor discs, combustion housings, fan casings, exit ducts, et cetera for both aerospace and power generation land based gas turbines.

As used herein, the terms “first,” “second,” “third”, and “fourth” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The singular forms “a,” “an,” and “the” include plural references unless the context clearly dictates otherwise.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims.

The disclosure as claimed is:

1. A system for treating a gas turbine component to effectuate a change in a surface of the gas turbine component, the system comprising:
a composite blast media configured to be propelled onto the surface of the gas turbine component using a media blasting device, the composite blast media including a carrier material and abrasive media embedded in the carrier material;
whereby, the carrier material entraps at least a part of a substance released from the surface upon contact with the composite blast media.

2. The system of claim 1, wherein the carrier material includes at least one void for entrapping the at least a part of a substance.

3. The system of claim 1, wherein the gas turbine component is an aerospace component.

4. The system of claim 3, wherein the aerospace component is at least one of a vane of a high pressure turbine and a blade of the high pressure turbine.

5. The system of claim 1, wherein the carrier material includes polyurethane.

6. The system of claim 5, wherein the abrasive media includes aluminum oxide.

7. The system of claim 3, wherein the system is configured to remove an environmental coating from the surface of the aerospace component.

8. The system of claim 3, wherein the system is configured to clean the surface of the aerospace component.

9. A method for media blasting a surface of a gas turbine component, the method comprising:
using a media blasting device to blast the surface of the gas turbine component with a composite blast media, the composite blast media including a carrier material and abrasive media embedded in the carrier material;
whereby, the carrier material entraps at least a part of a substance released from the surface upon contact with the composite blast media.

10. The method of claim 9, wherein the carrier material includes at least one void for entrapping the at least a part of a substance.

11. The method of claim 10, wherein the carrier material includes polyurethane.

12. The method of claim 10, wherein abrasive media includes aluminum oxide particulate.

13. The method of claim 10, further comprising propelling the composite blast media onto the surface to remove an environmental coating from the surface.

14. The method of claim 10, further comprising propelling the composite blast media onto the surface to clean engine buildup from the surface.

15. The method of claim 9, wherein the gas turbine component is an aerospace component.
